(19) United States
(12) Patent Application Publication
(10) Pub. No.: US 2002/0186866 A1
(43) Pub. Date: Dec. 12, 2002

(54) Inspection system process

(76) Inventors: Sally A. Pizak, Twin Lakes, WI (US); Ralph D. Sagel, Ingelside, IL (US)

Correspondence Address: REISING ETHINGTON BARNES KISSELLE, LEARMAN AND MCCULLOCH PC, P O BOX 4390, TROY, MI, 48099-4390, US

(21) Appl. No.: 09/878,018

(22) Filed: Jun. 8, 2001

(51) Int. Cl. G06K 9/36; G06T 3/00; G06T 7/00

(52) U.S. Cl. 382/112; 382/162; 382/285; 382/294

(57) ABSTRACT

A method for preparing an art design for final inspection. The method includes the steps of approving an art design; converting same to a grayscale image; distorting the image for flexographic printing; creating a negative for each color; layering negatives together to create a composite; sending the composite to an image setter; and inspecting for accuracy by comparing the composite to the grayscale image.

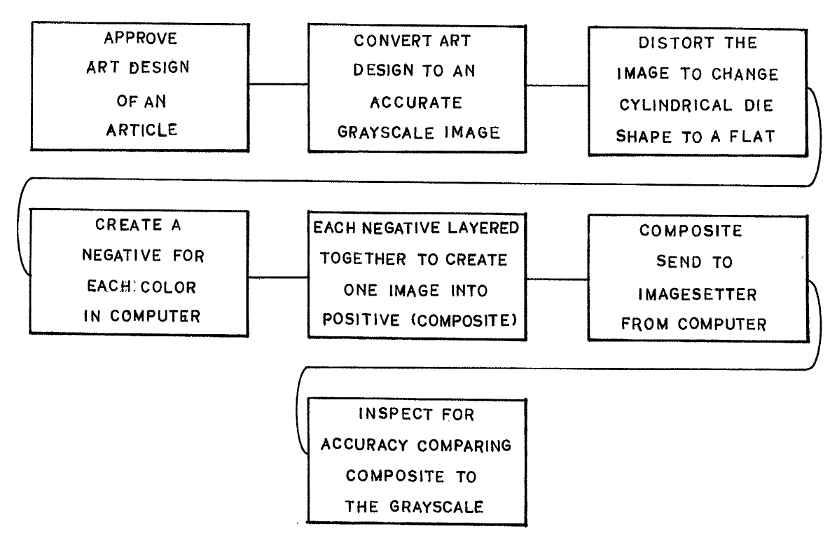

### TECHNICAL FIELD

This invention relates generally to printed articles, such as container lids, and, more particularly, to a method for preparing art work of the articles for inspection of the printed matter thereon by suitable camera equipment prior to starting production on high speed presses.

### BACKGROUND ART

Heretofore, the inspection process for determining the accuracy of the printed art work has comprised a visual inspection with the naked eye of the art work created by negatives, and/or using a camera proofing system adapted to reading the printed matter while a printed web is moving along a printing press production line.

Production time and costs will not be lost if 100% accuracy of the printed matter is assured by a novel preparation process in the art room prior to production.

### DISCLOSURE OF THE INVENTION

A general object of the invention is to provide an improved method for preparing art work for inspecting the printed matter on an article for accuracy in the art room prior to production.

Another object of the invention is to provide a method for preparing printed art work for inspection by a suitable camera system adapted to detect any omissions, or extraneous imaging to, the printed matter thereon.

A further object of the invention is to provide such a method of preparation including the making of an accurate “grayscale”; distorting same to illustrate on “the flat” the equivalent of the shape of cylinder lids on a web traveling around a cylindrical die on a printing press; making a negative of each color applied to the lid; and making a composite of the negatives in a layered configuration on the original distorted grayscale for comparison thereto.

A still further object of the invention is to provide a method for inspecting the printed matter on an article for accuracy including the steps of (1) converting an image of a desired art work to an accurate “grayscale”, distorted as required for flexographic printing, i.e. to illustrate the lid in a flat configuration to compensate for its arcuate position over conventional rubber mounted dies on cylinders along a high speed printing press; (2) in a computer, setting up art work to be separated into individual colors; (3) creating a negative (file) for each color included in the art work; (4) with image process software, joining each negative to an image setter in a layered configuration, and producing a positive or composite of the layered configuration; and (5) inspecting the composite by eye or by a suitable proofing system, by comparing the composite to the “grayscale” for errors of omission or addition.

A suitable proofing system may consist of a high resolution digital black and white camera and cooperating imaging software capable of reading a “5 point” typeface, and with the known ability to give an electronic signal for any spots where a required mark, such as a semi colon, is missing, and any spot which is an extra, undesired mark of some kind. Such a proofing system is available from PC Industries of Gurnee, Ill.

These and other objects and advantages of the inventive method will become more apparent when reference is made to the following drawing and written description.

### BRIEF DESCRIPTION OF THE DRAWINGS

The single FIGURE is a diagrammatic representation of the method of preparation of a design of an article, such as a container lid composite, for comparison to a distorted grayscale image of the article.

### BEST MODE FOR CARRYING OUT THE INVENTION

Referring now to the single FIGURE drawing in greater detail, there is represented therein the general steps of (1) approving a container lid design; (2) converting one image of the container lid design to a so-called “grayscale” image, as will be explained; (3) distorting the grayscale image as required to depict as a flat image a container lid comparable to its rolling over printing press cylinders covered by dies for applying respective colors onto a web on which the lids are being formed; (4) creating a negative for each color involved in the art design in the above referenced distorted configuration; (5) layering the negatives on top of one another; (6) making a positive (composite) of the layered negatives; and (7) comparing the positive to the underlying grayscale image for any errors in the printed matter on respective negative layers making up the positive.

The above referenced “grayscale” image is a facsimile of the approved container lid design in black for the words, numbers, and logos on a gray background, with any white portions remaining white.

More specifically, step (1) is the art design required by a customer for its container full of product. Step (2) is performed in a computer wherein step (3) and step (4) are also accomplished. Through image process software, via Raster Image Processor (RIP) the respective negatives are sent to an image setter for aligned layering (step 5), and the producing of a positive or composite of the combination (step 6). In other words, the composite represents the complete original art design as it will occur on the subsequent high speed press production line, embodying all the various art work, ready for a precise inspection comparing the composite to the underlying grayscale image. While such inspection can be accomplished with the naked eye, for more assured accuracy, the high resolution camera and image processing board available from P C Industries serve to produce the above referenced electronic signals to indicate exactly any changes which must be made to any one or more of the individual negatives prior to production.

### Industrial Applicability

It should be apparent that the inventive process provides a novel and efficient manner for assuring in a manufacturing art room that a customer's art is design will include complete accurate printing involved in the finished design, prior to any high speed production run on a printing press. This process insures that all required art work is present with no omission and without any extraneous images.

It should be further apparent that the inventive process saves substantial visual inspection time for the art inspection personnel operators.

What is claimed is:

1. A method for preparing art work for a printed article for inspection of variously printed matter thereon by suitable high resolution camera and imaging software equipment, prior to production on a high speed press, said method comprising the steps of:
a. preparing a grayscale image of an art work design;
b. distorting the grayscale image as required to compensate for changing a subsequent shape adjacent a cylindrical die to a flat planar attitude;
c. making a negative of each color involved in the art work design, each distorted the same as the grayscale image;
d. layering the negatives in register on top of one another;
e. making a composite of the layered negatives; and
f. comparing against the grayscale image for accuracy.

2. The method described in claim 1, wherein the distorting of the grayscale in step b is accomplished on a computer.

3. The method described in claim 1, wherein the making of the negatives in step c is accomplished on a computer.

4. The method described in claim 3, wherein the negatives in the computer are sent to image process software which joins the negatives to an image setter apparatus to accomplish the layering of step 1d and the making of the composite of step 1e.

5. The method described in claim 1, wherein the composite of step f is compared against the grayscale image, and inspected for accuracy by one of the naked eye or a high intensity camera and cooperating imaging software adapted to point out any omissions or extraneous details in the art work.

6. The method described in claim 1, wherein the article is a multi colored container lid.
